(19) United States
(12) Patent Application Publication
(10) Pub. No.: US 2009/0308329 A1
(43) Pub. Date: Dec. 17, 2009

(54) Animal leash

(76) Inventor: Adrian Sanchez, San Marino, CA (US)

Correspondence Address: DAVID AND RAYMOND PATENT FIRM, 108 N. YNEZ AVE., SUITE 128, MONTEREY PARK, CA, 91754, US

(21) Appl. No.: 12/157,811

(22) Filed: Jun. 13, 2008

(51) Int. Cl. A01K 27/00

(52) U.S. Cl. 119/795

(57) ABSTRACT

An animal leash includes an attachment strip and a safety handling grip. The attachment strip has an attaching end portion attaching to the animal, and a handling end portion extended from the attaching end portion to an animal owner. The safety handling grip includes a handle body rotatably coupled with the handling end portion of the attachment strip, and an elongated grip handle extended from the handle body for the animal owner to sufficiently and optimally grip on the elongated grip handle, in such a manner that when the animal causes the attachment strip to twist, the handle grip is adapted to rotate with respect to the attachment strip for substantially relieving a twisting force induced on the handling end portion of the attachment strip as a result of the animal movement, so as to avoid potential injury to a corresponding hand of the animal owner.

### BACKGROUND OF THE PRESENT INVENTION

1. Field of Invention

The present invention relates to an animal accessory, and more particularly to an animal leash comprising a safety handling grip for avoiding injury on the part of a user's hand while allowing maintaining substantial control on the animal.

2. Description of Related Arts

A conventional animal leash usually comprises an attachment strip having an attachment end portion attaching to an animal, such as a dog, and a handling end portion extended from the attachment end portion for being gripped on by a user, such as the owner of the animal. Very often, the handling end portion of the attachment strip is formed as having a loop so that a user is able to either directly grab on the attachment strip (i.e. the strip forming the loop) or penetrate his or her hand through the loop and tighten the attachment strip around his or her wrist so as to avoid accidental slipping of the attachment strip from the user's hand.

There exist a number of disadvantages regarding the conventional animal leash. First, when the animal is very active and always walk faster than the animal owner, holding the loop of the attachment strip may be uncomfortable because there may have only a little contact area between the owner's hand and the loop of the attachment strip (such as when the animal owner is only holding the surrounding fabric constituting the loop without actually penetrating his or her hand through the loop and tightening the remaining fabric of the handling end portion of the attachment strip around his or her wrist portion).

Second, when the animal owner is holding a relatively larger or bulky animal, he or she may need to put his or her hand into the loop and tighten the remaining fabric around his or her waist portion in order to avoid accidental release of the animal when the animal struggles to be released from the animal owner's control. The disadvantage of this practice (i.e. wrist holding) is that when the animal tries to move around too vigorously, the user's wrist may be vigorously pulled by the attachment strip as well so that the user's wrist might get hurt very easily. In some extreme cases, the irregular moving path of the animal may cause a severe twist on the part of the owner's wrist so that the animal owner may sustain a severe injury as a result.

### SUMMARY OF THE PRESENT INVENTION

A main object of the present invention is to provide an animal leash comprising a safety handling grip for avoiding injury on the part of a user's hand while allowing maintaining substantial control on the animal.

Another object of the present invention is to provide an animal leash comprising a safety handling grip, which is capable of substantially relieving a twisting force exerted by the animal to the animal owner while allowing him or her to exercise substantial control to the animal. In other words, the animal owner is able to exercise substantial control to the animal without fearing of wrist sustaining injury.

Another object of the present invention is to provide an animal leash comprising a safety handling grip, wherein the animal leash is adapted to guide and exercise control over a wide variety of animal of vary sizes. Thus, the present invention is suitable for use in a wide variety of circumstances and by a wide variety of users.

Another object of the present invention is to provide an animal leash comprising a safety handling grip, which is ergonomically featured to allow the animal owner to grip thereon in the most comfortable and effective manner.

In order to accomplish the above object, the present invention provides an animal leash for attaching to an animal by an animal owner, comprising:

an attachment strip having an attaching end portion adapted for attaching to the animal, and a handling end portion extended from the attaching end portion to the animal owner; and

a safety handling grip which comprises a handle body rotatably coupled with the handling end portion of the attachment strip, and an elongated grip handle, having length greater than a width of a palm of the animal owner, extended from the handle body for the animal owner to sufficiently and optimally grip on the elongated grip handle, in such a manner that when the animal causes the attachment strip to twist, the handle grip is adapted to rotate with respect to the attachment strip for substantially relieving a twisting force induced on the handling end portion of the attachment strip as a result of the animal movement, so as to avoid potential injury to a corresponding hand of the animal owner, while allowing the user to maintain effective pulling force to the attachment strip for substantially controlling a movement of the animal.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of an animal leash according to a preferred embodiment of the present invention.

FIG. 2 is a perspective view of an animal leash according to the above preferred embodiment of the present invention.

FIG. 3 is a second schematic diagram of an animal leash according to the above preferred embodiment of the present invention.

FIG. 4 is a partial perspective view of the animal leash according to the above preferred embodiment of the present invention.

FIG. 5 is a first alternative mode of the animal leash according to the above preferred embodiment of the present invention.

FIG. 6 is a second alternative mode of the animal leash according to the above preferred embodiment of the present invention.

FIG. 7 is a schematic diagram of the second alternative mode of the animal leash according to the above preferred embodiment of the present invention.

FIG. 8 is a schematic diagram of the third alternative mode of the animal leash according to the above preferred embodiment of the present invention.

### DETAILED DESCRIPTION OF THE PREFERRED EMBODIMENT

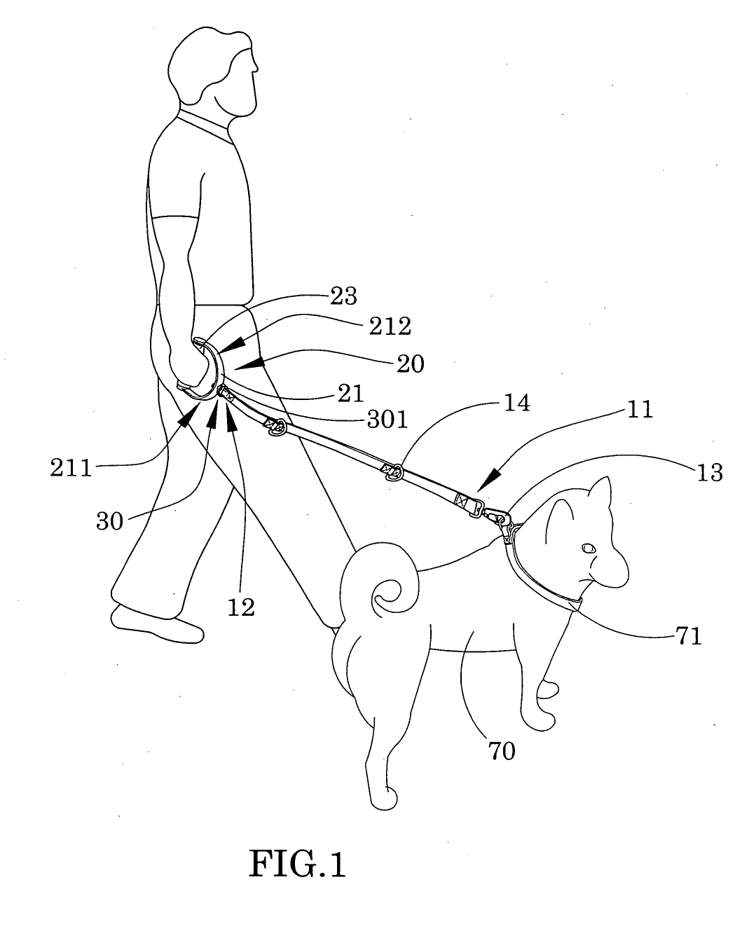

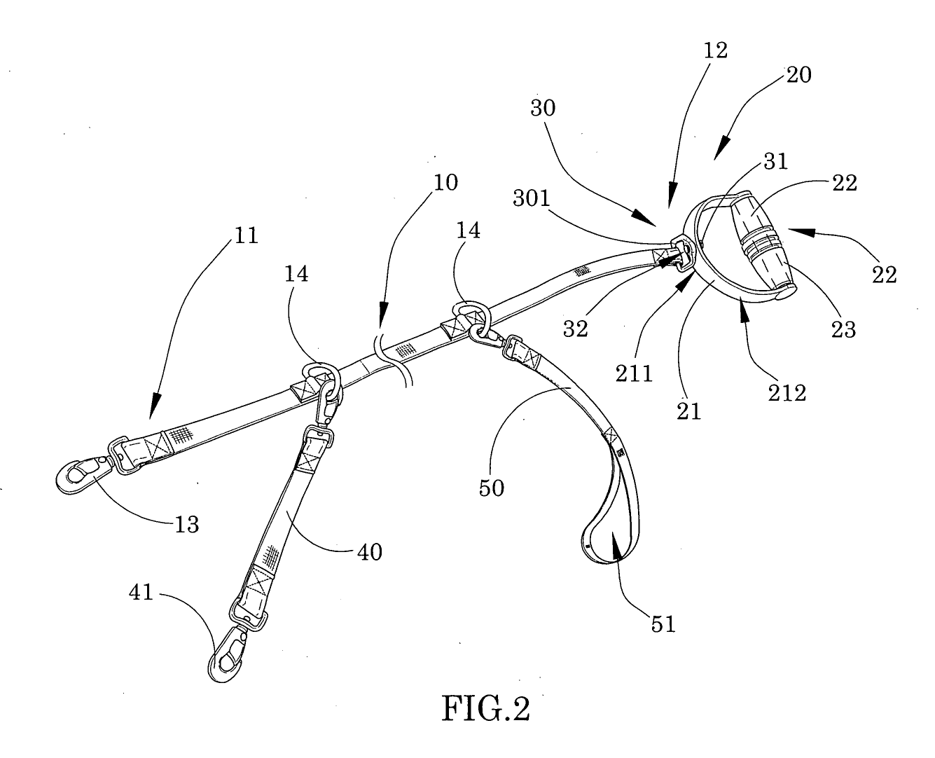

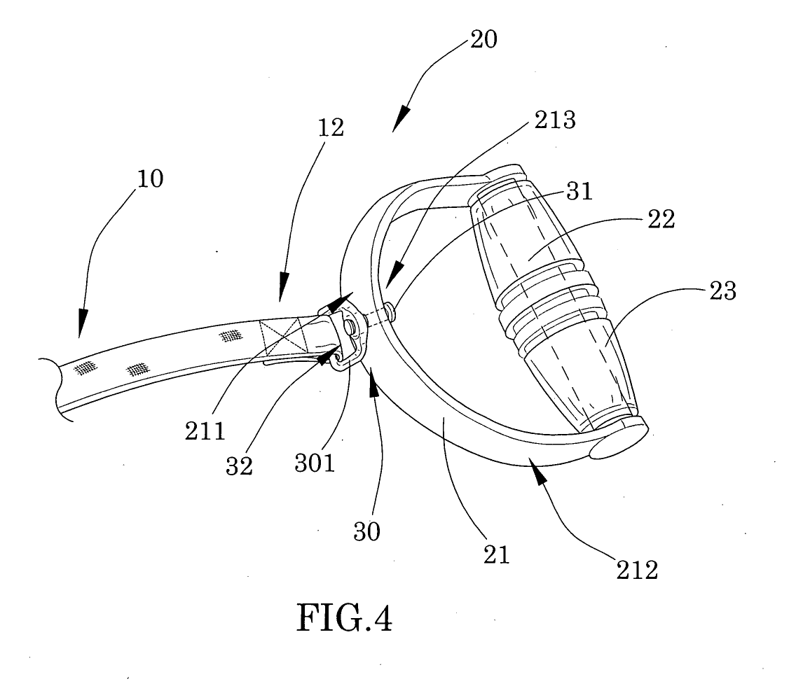

Referring to FIG. 1 to FIG. 4 of the drawings, an animal leash for attaching to an animal 70, such as a pet dog, by an animal owner according to a preferred embodiment of the present invention is illustrated, in which the animal leash comprises an elongated attachment strip 10 and a safety handling grip 20.

The attachment strip 10 has an attaching end portion 11 adapted for attaching to the animal 70, preferably through an animal collar 71, and a handling end portion 12 extended from the attaching end portion 11 to the animal owner, i.e. the user of the present invention.

The safety handling grip 20 comprises a rigid handle body 21 rotatably coupled with the handling end portion 12 of the attachment strip 10, and an elongated grip handle 22, having length greater than a width of a palm of the animal owner, extended from the handle body 21 for the animal owner to sufficiently and optimally grip on the elongated grip handle 22, in such a manner that when the animal causes the attachment strip 10 to twist, the handle grip 22 is adapted to rotate with respect to the attachment strip 10 for substantially relieving a twisting force induced on the handling end portion 12 of the attachment strip 10 as a result of the animal movement, so as to avoid potential injury to a corresponding hand of the animal owner, while allowing the user to maintain effective pulling force to the attachment strip 10 for substantially controlling a movement of the animal.

According to the preferred embodiment of the present invention, the attachment strip 10 comprises a releasable lock 13 attached onto the attaching end portion 11 of the attachment strip 10 to releasably connect with the animal collar 71, wherein a user is able to selectively and detachably connect the attachment strip 10 to the animal 70 through the animal collar 71 and the releasable lock 13. It is worth mentioning that the releasable lock 13 can be embodied as a traditional manual clasp adapted for releasably and manually fastening to the animal collar 71.

The animal leash further comprises a connecting arrangement 30 mounted between the handle body 21 of the safety handling grip 20 and the handling end portion 12 of the attachment strip 10 in such a manner that the safety handling grip 20 is capable of rotating with respective to the attachment strip 10 so as to rotatably mount the safety handling grip 20 with the attachment strip 10. More specifically, the connecting arrangement 30 comprises a connecting element 301 which is a rigid connecting frame having a predetermined strength for rotatably mounting between the handle body 21 and the handling end portion 12 of the attachment strip 10.

According to the preferred embodiment of the present invention, the handle body 21 has a curved bottom portion 211 and two elongated arm portions 212 integrally extended from two ends of the curved bottom portion 211 to define a U-shaped cross section of the handle body 21, wherein the handle body 21 further has a connecting hole 213 formed on the curved bottom portion 211 thereof wherein a first end of the connecting element 301 is fastened to the curved bottom portion 211 through the connecting hole 213 and a connector 31, while a second end of the connecting element 301 is fastened to the handling end portion 12 of the attachment strip 10. In other words, the safety handling grip 20 is capable of rotating with respective to the attachment strip 10 so as to relieve any twisting force exerted onto the handling end portion 12 of the attachment strip 10 when the animal 70 is vigorously moving in varies directions.

It is worth mentioning that the connecting element 301 has a through connecting slot 32 formed between the first end and the second end of the connecting arrangement 30 wherein the handing end portion 12 is connected with first end and the connector 31 is rotatably connected with the second end of the connecting arrangement 30.

The safety handling grip 20 further comprises a handle cushion 23 mounted onto the elongated grip handle 22 which is integrally extended between the two elongated arm portions 212 of the handle body 21 of the safety handling grip 20, wherein a user is able to conveniently and comfortably grip on the elongated grip handle 22 through the handle cushion 23 for exercise substantial control over the movement of the relevant animal 70 fastened on the attachment end portion 11 of the attachment strip 10. Note that a length of the handle cushion 23 should be the same as the elongated grip handle 22 so that a user is able to grip on the elongated grip handle 22 in the most ergonomically-friendly manner.

In other words, the user is able to exercise the greatest amount of pulling force to control the movement of the animal 70 without being imparted substantial strain onto his or her palm or the gripping hand.

According to the preferred embodiment of the present invention, the animal leash further comprises at least one supplemental attachment member 40 for connecting an additional animal 70 with the attachment strip 10. More specifically, the supplemental attachment member 40 is also elongated in shape and detachably extended from the attachment strip 10, and comprises a supplemental releasable lock 41 for releasably locking with the animal collar 71 of that additional animal 70. Accordingly, the elongated attachment strip 10 further comprises a plurality of connecting members 14 spacedly provided thereon for mounting with the supplemental attachment member 40 so as to releasably connect the supplemental attachment member 40 with the elongated attachment strip 10. It is worth mentioning that more than one supplemental attachment members 40 may be attached onto the elongated attachment strip 10 for allowing the user to control a number of animals by using only one safety handling grip.

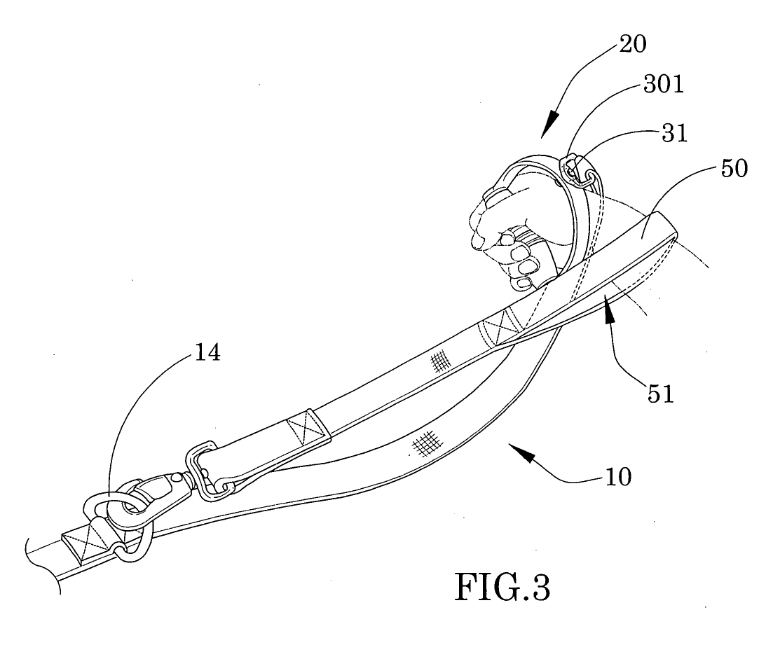

Moreover, the animal leash further comprises a wrist holding strap 50 releasably extended from the elongated attachment strip 10 for allowing the user to reinforce his/her holding strength through the use of a wrist holding strap 50. More specifically, the wrist holding strap 50 is releasably connected with one of the connecting members 14, and has a wrist holding loop 51 formed thereon for allowing a user's wrist to pass therethrough for fastening the animal leash to the user's arm. After that, the user is able to grab the safety handling grip 20 for exerting the controlling force to the animal while securely fastening to the animal leash through the wrist holding loop 51, as shown in FIG. 3 of the drawings. It is important to point out that the user is free to use the wrist holding strap 50 whenever the circumstances require. This is an option offered to the user of the present invention.

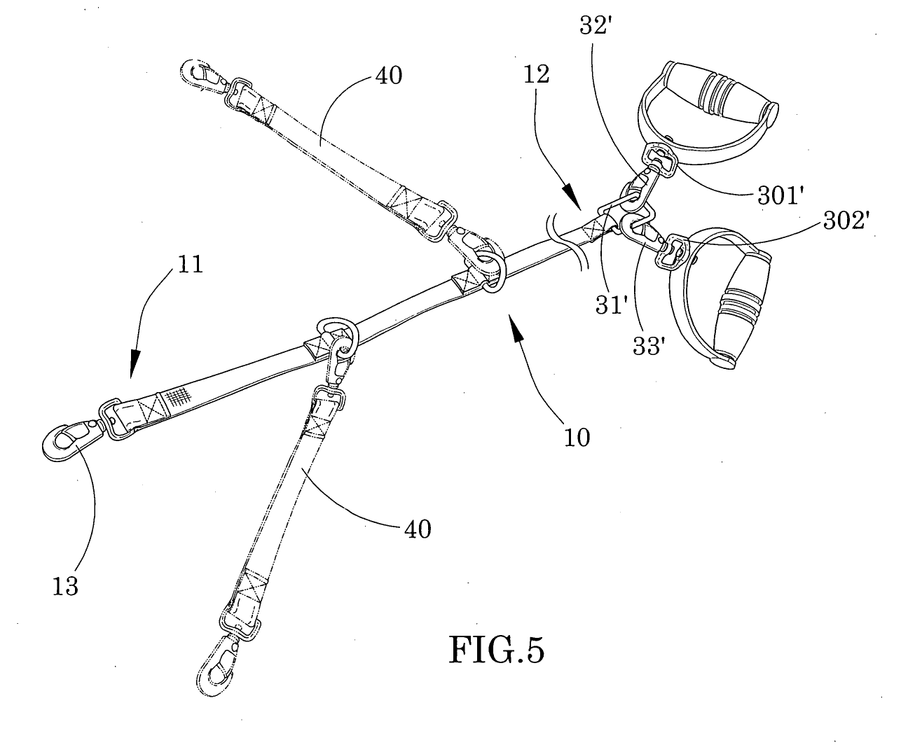

Referring to FIG. 5 of the drawings, a first alternative mode of the animal leash according to the preferred embodiment of the present invention is illustrated. The first alternative mode is similar to the preferred embodiment, except the connecting arrangement 30′ and that the animal leash further comprises one more safety handling grip 20′ (i.e. a first safety handling grip 20 and a second safety handling grip 20′) attached onto the handling end portion 12 of the attachment strip 10 so that a user is able to utilize both of his or her hands for controlling the animal 70. Since the user is able to control the animal 70 by both of his or her hands, the stress sustained by the user's hands are further relieved while control over the animal is maintained.

More specifically, the connecting arrangement 30′ comprises a main fastener 31′, a first and a second connecting lock 32′, 33′, and a first and a second connecting elements 301′, 302′, wherein the first and the second safety handling grip 20, 20′ are connected with the handling end portion 12 through the main fastener 31′, and the corresponding connecting lock 32′ (33′) and the connecting element 301′ (302′). As shown in FIG. 5 of the drawings, the main fastener 31′ is fastened at the handling end portion 12 of the attachment strip 10 while the first and the second connecting lock 32′, 33′ are connecting the main fastener 31′ with the first and the second connecting elements 301′, 302′ respectively. In turn, the first and the second connecting elements 301′, 302′ are rotatably connected with the first and the second handling grip 20, 20′ respectively so as to rotatably connect the first and the second handling grip 20, 20′ with respective to the handling end portion 12 of the attachment strip 10. In this first alternative mode, the user is able to control a single animal through both of his or her hands. As shown in FIG. 5 of the drawings, the animal leash of the first alternative mode can also be utilized with a plurality of supplemental attachment members 40.

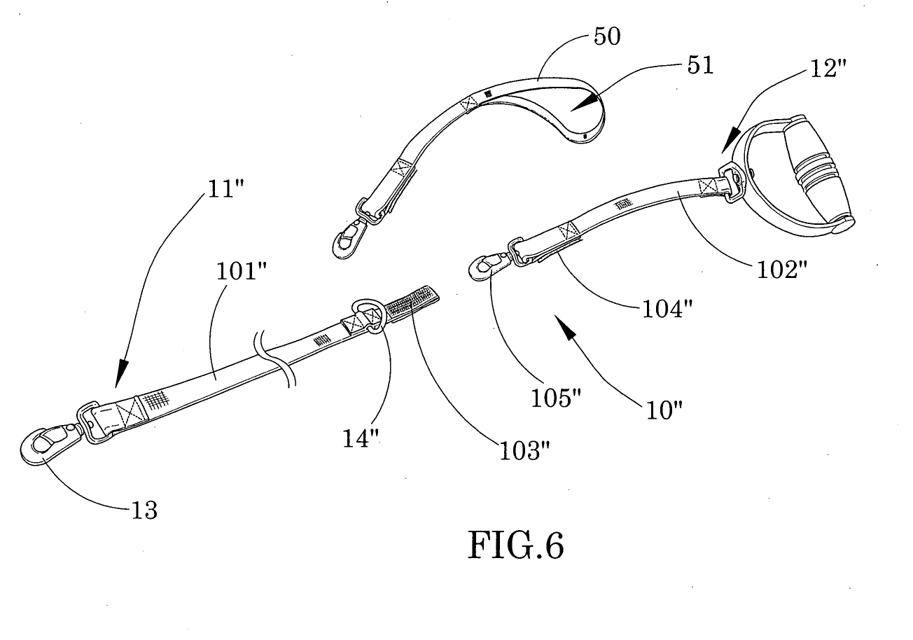

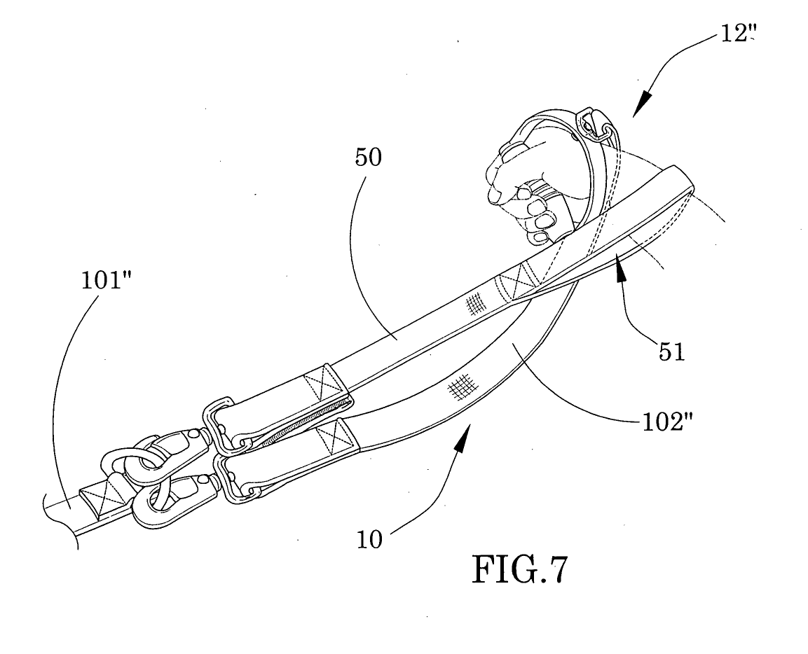

Referring to FIG. 6 to FIG. 7 of the drawings, a second alternative mode of the animal leash according to the preferred embodiment of the present invention is illustrated. The second alternative mode is similar to the preferred embodiment except the elongated attachment strip 10″. According to the second alternative mode, the elongated attachment strip 10″ comprises a first and a second strip member 101″, 102″ detachably attached with each other through a hook fastener 103″ and loop fastener 104″, and an attachment lock 105″. The attaching end portion 11″ is formed as an end portion of the first strip member 101″, while the handling end portion 12″ is formed as an end portion of the second strip member 102″, wherein the first and the second strip member 101″, 102″ are detachably attached with each other by attaching the hook fastener 103″ with the loop fastener 104″ and by locking the attachment lock 105″ with one of the connecting members 14″. Moreover, the wrist holding strap 50 can also be detachably attached onto the connecting member 14″ through a lock and/or a hoop and loop fastener. It is also worth mentioning that the second strip member 102″ and the wrist holding strap 50 is replaceably attached onto the first strip member 102″ so as to allow the user to use the present invention in a wide variety of circumstances. The user can also utilize both the wrist holding strap 50 and the second strip member 102″ as shown in FIG. 7 of the drawings.

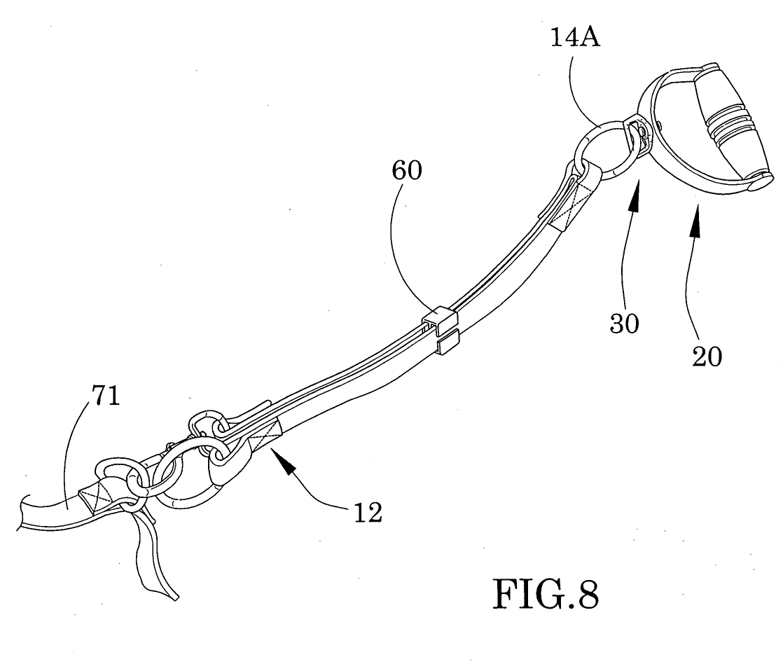

FIG. 8 of the drawings illustrates a third alternative mode of the animal leash of the present invention in which safety handling grip 20 is rotatably provided at a mid-portion of the attachment strip 10 through a connecting member 14A and the connecting arrangement 30, while the attaching end portion 11 and the handling end portion 12 are detachably connected with each other and further connected to the animal 70 via a collar 71 and releasable locks 13 and connecting member 14A for allowing a user to reduce the length of the attachment strip 10 extended between the safety handling grip 20 and the animal 70. In other words, the attachment strip 10 is approximately folded in half to reduce a length between the safety handling grip 20 and the animal 70. As such, the user of the present invention can make up his or her own way to lead the animal 70 by using the animal leash of the present invention.

The animal leash further comprises a connecting clip 60 detachably mounted onto the attachment strip 10 to fasten the two parts of the attachment strip 10 which is approximately folded in half so as to prevent the attachment strip 10 from severely deforming when the animal leash is leading or guiding the animal 70.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An animal leash for attaching to an animal by an animal owner, comprising:
an attachment strip having an attaching end portion attaching to said animal, and a handling end portion extended from said attaching end portion to said animal owner; and
a safety handling grip which comprises a rigid handle body rotatably coupled with said handling end portion of said attachment strip, and an elongated grip handle, having length greater than a width of a palm of said animal owner, extended from said handle body for said animal owner to sufficiently and optimally grip on said elongated grip handle, in such a manner that when said animal causes said attachment strip to twist, said handle grip is adapted to rotate with respect to said attachment strip for substantially relieving a twisting force induced on said handling end portion of said attachment strip as a result of said animal movement, so as to avoid potential injury to a corresponding hand of said animal owner, while allowing said user to maintain effective pulling force to said attachment strip for substantially controlling a movement of said animal.

2. The animal leash, as recited in claim 1, further comprising a connecting arrangement mounted between said handle body of said safety handling grip and said handling end portion of said attachment strip in such a manner that said safety handling grip is capable of rotating with respective to said attachment strip so as to rotatably mount said safety handling grip with said attachment strip.

3. The animal leash, as recited in claim 2, wherein said connecting arrangement comprises a connecting element having a first and a second end and a predetermined strength for rotatably mounting between said handle body and said handling end portion of said attachment strip, wherein said connecting element has a through connecting slot formed between said first end and said second end of said connecting arrangement wherein said handling end portion is connected with said first end and said connecting element is rotatably connected with said second end through a connector.

4. The animal leash, as recited in claim 3, wherein said attachment strip comprises a releasable lock attached onto said attaching end portion of said attachment strip to releasably connect with said animal.

5. The animal leash, as recited in claim 3, wherein said handle body has a curved bottom portion and two elongated arm portions integrally extended from two ends of said curved bottom portion to define a U-shaped cross section of said handle body, wherein said handle body further has a connecting hole formed on said curved bottom portion thereof wherein said connecting arrangement is fastened between said curved bottom portion through said connecting hole and said attachment strip at said handling end portion in such a manner that said handle body is capable of rotating with respect to said attachment strip.

6. The animal leash, as recited in claim 4, wherein said handle body has a curved bottom portion and two elongated arm portions integrally extended from two ends of said curved bottom portion to define a U-shaped cross section of said handle body, wherein said handle body further has a connecting hole formed on said curved bottom portion thereof wherein said connecting arrangement is fastened between said curved bottom portion through said connecting hole and said attachment strip at said handling end portion in such a manner that said handle body is capable of rotating with respect to said attachment strip.

7. The animal leash, as recited in claim 5, wherein said safety handling grip further comprises a handle cushion mounted onto said elongated grip handle which is integrally extended between said two elongated arm portions of said handle body of said safety handling grip, wherein a user is able to conveniently and comfortably grip on said elongated grip handle through said handle cushion for exercising substantial control over a movement of said animal fastened on said attachment end portion of said attachment strip.

8. The animal leash, as recited in claim 6, wherein said safety handling grip further comprises a handle cushion mounted onto said elongated grip handle which is integrally extended between said two elongated arm portions of said handle body of said safety handling grip, wherein a user is able to conveniently and comfortably grip on said elongated grip handle through said handle cushion for exercising substantial control over a movement of said animal fastened on said attachment end portion of said attachment strip.

9. The animal leash, as recited in claim 7, wherein a length of said handle cushion is the same as said elongated grip handle so that a user is able to grip on said elongated grip handle in a most ergonomically friendly manner.

10. The animal leash, as recited in claim 8, wherein a length of said handle cushion is the same as said elongated grip handle so that a user is able to grip on said elongated grip handle in a most ergonomically friendly manner.

11. The animal leash, as recited in claim 1, further comprising at least one supplemental attachment member for connecting another of said animal with said attachment strip, wherein said supplemental attachment member is also elongated in shape and detachably extended from said attachment strip.

12. The animal leash, as recited in claim 10, further comprising at least one supplemental attachment member for connecting another of said animal with said attachment strip, wherein said supplemental attachment member is also elongated in shape and detachably extended from said attachment strip.

13. The animal leash, as recited in claim 11, wherein said elongated attachment strip further comprises a plurality of connecting members spacedly provided thereon for mounting with said supplemental attachment member so as to releasably and detachably connect said supplemental attachment member with said elongated attachment strip.

14. The animal leash, as recited in claim 12, wherein said elongated attachment strip further comprises a plurality of connecting members spacedly provided thereon for mounting with said supplemental attachment member so as to releasably and detachably connect said supplemental attachment member with said elongated attachment strip.

15. The animal leash, as recited in claim 13, further comprising a wrist holding strap releasably extended from said elongated attachment strip for allowing said user to reinforce a holding strength through said wrist holding strap while gripping on said safety handling grip.

16. The animal leash, as recited in claim 14, further comprising a wrist holding strap releasably extended from said elongated attachment strip for allowing said user to reinforce a holding strength through said wrist holding strap while gripping on said safety handling grip.

17. The animal leash, as recited in claim 1, further comprising one more said safety handling grip attached onto said handling end portion of said attachment strip so that a user is able to utilize both hands for controlling said animal, wherein said connecting arrangement comprises a main fastener, a first and a second connecting strips, and a first and a second connecting element, wherein said two safety handling grips are rotatably connected with said handling end portion through said main fastener, and said corresponding connecting strip and said connecting elements respectively.

18. The animal leash, as recited in claim 16, further comprising one more said safety handling grip attached onto said handling end portion of said attachment strip so that a user is able to utilize both hands for controlling said animal, wherein said connecting arrangement comprises a main fastener, a first and a second connecting strips, and a first and a second connecting element, wherein said two safety handling grips are rotatably connected with said handling end portion through said main fastener, and said corresponding connecting strip and said connecting elements respectively.

19. The animal leash, as recited in claim 17, wherein connecting arrangement comprises a main fastener, a first and a second connecting lock, and a first and a second connecting element, wherein said safety handling grips are connected with said handling end portion through said main fastener, and said connecting locks and said connecting elements respectively.

20. The animal leash, as recited in claim 18, wherein connecting arrangement comprises a main fastener, a first and a second connecting lock, and a first and a second connecting element, wherein said safety handling grips are connected with said handling end portion through said main fastener, and said connecting locks and said connecting elements respectively.

21. The animal leash, as recited in claim 13, wherein said elongated attachment strip comprises a first and a second strip member detachably attached with each other, wherein said attaching end portion is formed as an end portion of said first strip member, while said handling end portion is formed as an end portion of said second strip member, wherein said wrist holding strap is detachably attached onto said corresponding connecting member so that said user is capable of utilizing both said wrist holding strap and said second strip member for holding said animal in a maximum strength.

22. The animal leash, as recited in claim 14, wherein said elongated attachment strip comprises a first and a second strip member detachably attached with each other, wherein said attaching end portion is formed as an end portion of said first strip member, while said handling end portion is formed as an end portion of said second strip member, wherein said wrist holding strap is detachably attached onto said corresponding connecting member so that said user is capable of utilizing both said wrist holding strap and said second strip member for holding said animal in a maximum strength.
